(19) United States
(12) Patent Application Publication
(10) Pub. No.: US 2014/0062831 A1
(43) Pub. Date: Mar. 6, 2014

(54) SWITCHING CIRCUIT

(71) Applicant: SAMSUNG ELECTRO-MECHANICS CO., LTD., Suwon (KR)

(72) Inventor: Chan Yong JEONG, Seoul (KR)

(73) Assignee: SAMSUNG ELECTRO-MECHANICS CO., LTD., Suwon (KR)

(21) Appl. No.: 14/073,385

(22) Filed: Nov. 6, 2013

(30) Foreign Application Priority Data
Apr. 5, 2012 (KR) 10-2013-037442

(51) Int. Cl. H01Q 1/50

(52) U.S. Cl. CPC H01Q 1/50
USPC 343/876

(57) ABSTRACT

The present invention relates to a switching circuit, which can adjust characteristics such as insertion loss, isolation, and reflection loss according to the need by including a plurality of input/output terminals; at least one antenna; a plurality of main switches for connecting or disconnecting between each of the plurality of input/output terminals and the antenna; and a plurality of shunt switches having one ends respectively connected to the plurality of input/output terminals, wherein a voltage of less than 0 is applied to the other end of at least one of the plurality of shunt switches.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2013-0037442, entitled filed Apr. 5, 2013, which is hereby incorporated by reference in its entirety into this application.

### BACKGROUND OF THE INVENTION

1. Field of the Invention

The present invention relates to a switching circuit.

2. Description of the Related Art

In general, a switching circuit including an antenna is provided in wireless communication devices, which transmit and receive data through wireless communication, such as a mobile phone, a smartphone, and a tablet PC.

Owing to development of wireless communication and related technologies, various cellular communication technologies such as CDMA, GSM, and WCDMA are implemented in one wireless communication device. Furthermore, in recent times, efforts to implement wireless communication technologies such as WiFi and Bluetooth as well as cellular communication continue.

In these circumstances, the importance of an RF front-end for processing wireless signals is emphasized, and it is common that a switching circuit including an antenna is provided in the RF front-end.

Here, the switching circuit means a circuit that performs a function of inputting or outputting specific data into or from a specific input/output terminal by selectively connecting a plurality of input/output terminals to the antenna and may be classified as single pole single through (SPST), single pole double through (SPDT), or SP3T according to the number of input/output terminals connected to one antenna.

Meanwhile, in several characteristics of the switching circuit, insertion loss, return loss, and isolation correspond to important indexes that should be considered in circuit design, and these indexes may be determined according to characteristics and structure of switches constituting the switching circuit.

As described above, in order to perform various types of communication in one RF front-end, the characteristics of the switching circuit should be optimized for each communication technology.

However, the conventional typical switching circuits couldn't change these characteristic indexes once the switches are physically implemented.

Therefore, since the design should be performed to maximize an average gain for all wireless communication technologies that the switching circuit should perform, there were limitations in implementing a switching circuit having characteristics optimized for each wireless communication technology.

### RELATED ART DOCUMENT

### Patent Document

Patent Document 1: U.S. Pat. No. 7,460,852B2

### SUMMARY OF THE INVENTION

The present invention has been invented in order to overcome the above-described problems and it is, therefore, an object of the present invention to provide a switching circuit that can improve characteristics of a switching circuit and furthermore can adjust the characteristics of the switching circuit to be optimized to perform each wireless communication technology.

In accordance with one aspect of the present invention to achieve the object, there is provided a switching circuit including: a plurality of input/output terminals; at least one antenna; a plurality of main switches for connecting or disconnecting between each of the plurality of input/output terminals and the antenna; and a plurality of shunt switches having one ends respectively connected to the plurality of input/output terminals, wherein a voltage of less than 0 is applied to the other end of at least one of the plurality of shunt switches.

At this time, the plurality of input/output terminals may include a first input/output terminal and a second input/output terminal, the plurality of main switches may include a first main switch provided between the first input/output terminal and the antenna and a second main switch provided between the second input/output terminal and the antenna, the plurality of shunt switches may include a first shunt switch having one end connected to the first input/output terminal and the other end provided with a first port and a second shunt switch having one end connected to the second input/output terminal and the other end provided with a second port, and the voltage of less than 0 may be applied to the first port or the second port.

Further, the first shunt switch or the second shunt switch may include a control terminal to which a control signal is applied, and the voltage applied to the first port or the second port may be determined in the range in which a voltage between the other end of the first shunt switch or the second shunt switch and the control terminal is lower than a breakdown voltage of the first shunt switch or the second shunt switch.

Further, when the first main switch is in ON state, the second main switch may be in OFF state and the second shunt switch may be in ON state, and when the second main switch is in ON state, the first main switch may be in OFF state and the first shunt switch may be in ON state.

Further, when the first shunt switch is in OFF state, the voltage of less than 0 may be applied to the first port, and when the second shunt switch is in OFF stage, the voltage of less than 0 may be applied to the second port.

Further, the switching circuit may further include a variable potential controller connected to the first port and the second port to apply a voltage.

Further, the switching circuit may further include a variable potential controller connected to the other end of at least one of the plurality of shunt switches.

At this time, the plurality of shunt switches may include a control terminal, and it is preferred that the voltage applied to the other end of the shunt switch by the variable potential controller is determined in the range in which a voltage between the other end of the shunt switch and the control terminal is lower than a breakdown voltage of the shunt switch.

Further, the plurality of input/output terminals may include a first input/output terminal, a second input/output terminal, and a third input/output terminal, the plurality of main switches may include a first main switch provided between the first input/output terminal and the antenna, a second main switch provided between the second input/output terminal and the antenna, and a third main switch provided between the third input/output terminal and the antenna, the plurality of shunt switches may include a first shunt switch having one end connected to the first input/output terminal and the other end provided with a first port, a second shunt switch having one end connected to the second input/output terminal and the other end provided with a second port, and a third shunt switch having one end connected to the third input/output terminal and the other end provided with a third port, and the voltage of less than 0 may be applied to at least one of the first port, the second port, and the third port.

At this time, the switching circuit may further include a variable potential controller connected to the first port, the second port, and the third port to apply a voltage.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically showing a switching circuit in accordance with an embodiment of the present invention;

FIG. 2 is a view schematically showing a switching circuit in accordance with an embodiment of the present invention;

FIG. 3a is a view schematically showing insertion loss characteristics of the switching circuit in accordance with the embodiment of the present invention;

FIG. 3b is a view schematically showing isolation characteristics of the switching circuit in accordance with the embodiment of the present invention;

FIG. 3c is a view schematically showing reflection loss characteristics of the switching circuit in accordance with the embodiment of the present invention;

FIG. 4a is a view schematically showing insertion loss characteristics of a switching circuit in accordance with a comparative example;

FIG. 4b is a view schematically showing isolation characteristics of the switching circuit in accordance with the comparative example;

FIG. 4c is a view schematically showing reflection loss characteristics of the switching circuit in accordance with the comparative example;

FIG. 5 is a view schematically showing a switching circuit in accordance with an embodiment of the present invention; and

FIG. 6 is a view schematically showing a switching circuit in accordance with an embodiment of the present invention.

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Hereinafter, configurations and operational effects of the present invention will be described in detail with reference to the accompanying drawings.

FIG. 1 is a view schematically showing a switching circuit 100 in accordance with an embodiment of the present invention.

Referring to FIG. 1, a switching circuit 100 in accordance with an embodiment of the present invention may include a plurality of input/output terminals RF1 and RF2, an antenna ANT, main switches SW1 and SW2, and shunt switches SW1-1 and SW2-1.

The plurality of input/output terminals may include a first input/output terminal RF1 and a second input/output terminal RF2. The first input/output terminal RF1 may be connected to a wireless signal receiver which receives a wireless signal, and the second input/output terminal RF2 may be connected to a wireless signal transmitter which transmits a wireless signal.

Next, the main switches may be provided between the first input/output terminal RF1 and the antenna ANT and between the second input/output terminal RF2 and the antenna ANT, respectively. To help understanding, the main switch connected between the first input/output terminal RF1 and the antenna ANT will be referred to as a first main switch SW1, and the main switch connected between the second input/output terminal RF2 and the antenna ANT will be referred to as a second main switch SW2.

When an apparatus including the switching circuit 100 performs an operation of receiving data, the first main switch SW1 should be in ON state to transmit a signal input through the antenna ANT to the first input/output terminal RF1. At the same time, the second main switch SW2 should be in OFF state since the signal input through the antenna ANT shouldn't be transmitted to the second input/output terminal RF2.

Meanwhile, there is a recent trend of implementing the switching circuit 100 using switches consisting of HEMTs or MOSFETs, but these switches can't completely block all signals even in OFF state when the signals are strong. Therefore, switches having one end connected to input/output terminals and the other end grounded are additionally provided to minimize transmission of leaking signals to the input/output terminals. Generally, these switches are called shunt switches.

The above-described shunt switches are also provided in the switching circuit 100 in accordance with an embodiment of the present invention. The shunt switch having one end connected to the first input/output terminal RF1 will be referred to as a first shunt switch SW1-1, the shunt switch having one end connected to the second input/output terminal RF2 will be referred to as a second shunt switch SW2-1, the other end of the first shunt switch SW1-1 will be referred to as a first port Port A, and the other end of the second shunt switch SW2-1 will be referred to as a second port Port B.

However, unlike the prior art, in the switching circuit 100 in accordance with an embodiment of the present invention, a voltage of less than 0 may be applied to the other end of the shunt switch, that is, the first port Port A or the second port Port B.

Here, a voltage of less than 0 may be applied only to the first port Port A or the second port Port B or both of the first port Port A and the second port Port B. In all cases, the insertion loss, isolation, and reflection loss of the switching circuit 100 may be adjusted according to the size of the voltage applied to the first port Port A, the second port Port B, etc.

As described at the beginning, in the conventional typical switching circuit in which the other end of the shunt switch is grounded, the insertion loss, isolation, and reflection loss characteristics are physically fixed.

Therefore, even when the switching circuit 100 should process various wireless communication signals of different forms and standards, such as a cellular signal, a WiFi signal, and a Bluetooth signal, it was impossible to implement a switching circuit having characteristics optimized for each communication method and purpose.

That is, a switching circuit, which isn't optimized for all wireless communication methods but derives average characteristics capable of obtaining the best results in performing all the wireless communication methods and fixes the derived characteristics, has been implemented.

However, in the switching circuit 100 in accordance with an embodiment of the present invention, since a voltage of less than 0 is applied to the other end of the shunt switch, it is possible to adjust the insertion loss, isolation, and reflection loss of the switching circuit 100.

Accordingly, in the switching circuit 100 in accordance with an embodiment of the present invention, the switching circuit 100 can be adjusted to have the characteristics optimized for the corresponding method when performing the specific wireless communication method.

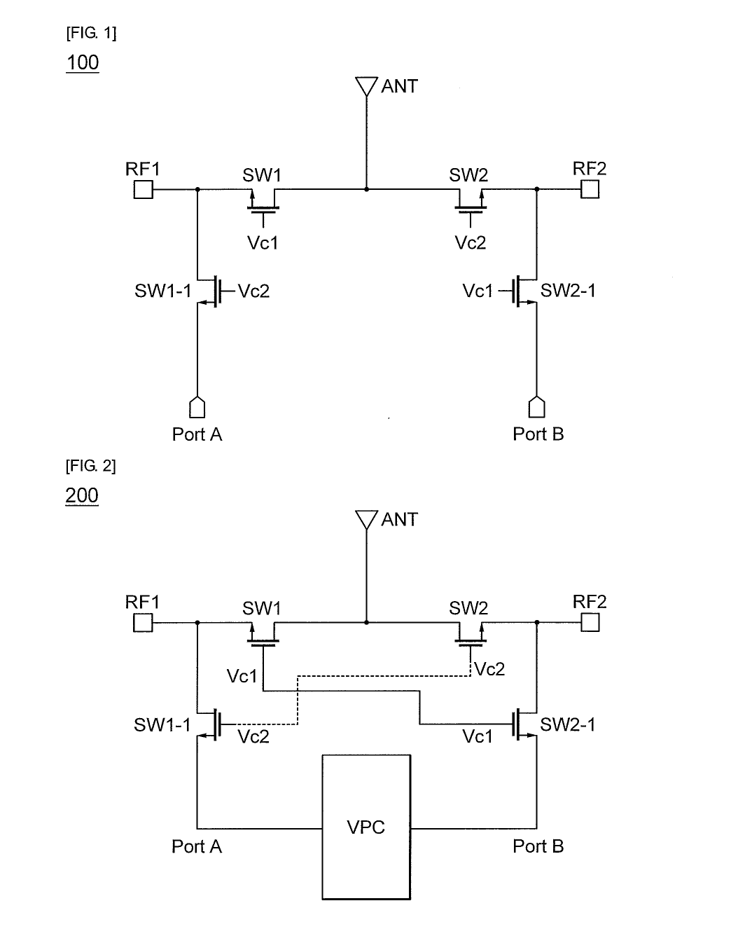

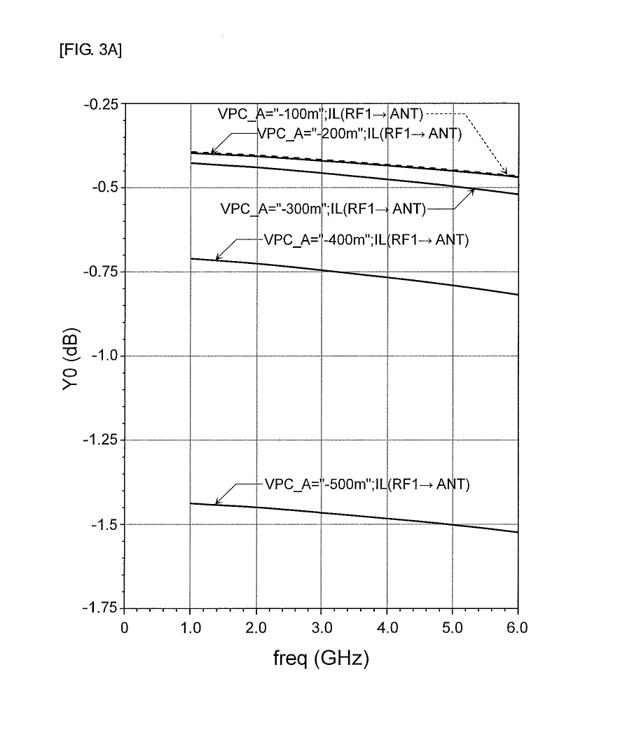

FIG. 2 is a view schematically showing a switching circuit 200 in accordance with an embodiment of the present invention.

Referring to FIG. 2, it will be understood that a switching circuit 200 in accordance with the present embodiment further includes a variable potential controller VPC connected to a first port Port A and a second port Port B, unlike the above-described embodiment.

At this time, although the drawing shows that the variable potential controller VPC is connected to both of the first port Port A and the second port Port B, the variable potential controller VPC may be connected to only one of the first port Port A and the second port Port B without being limited thereto. In this case, the other port may be grounded.

The variable potential controller VPC may perform a function of applying a voltage of less than 0 to at least one selected from the first port Port A and the second port Port B.

That is, the variable potential controller VPC can control a potential of the first port Port A or the second port Port B and thus can control the insertion loss, isolation, and reflection loss characteristics of the switching circuit 200.

Control signals Vc1 and Vc2 for controlling main switches and shunt switches of the switching circuit 200 may be generated by a controller for controlling the switching circuit 200, such as IC. It is possible to input and output a specific type of wireless communication signal into and from a specific input/output terminal according to this control signal.

For example, when the control signal is applied so that a first main switch SW1 and a second shunt switch SW2-1 are in ON state and a second main switch SW2 and a first shunt switch SW-1 are in OFF state, an antenna ANT and a first input/output terminal RF1 are connected to transmit and receive wireless communication signals.

Further, although some of the signals received through the antenna ANT or output from the first input/output terminal RF1 pass through the second main switch SW2 in OFF state, they can be removed by the second shunt switch SW2-1, thus reducing the influence on a second input/output terminal RF2.

At this time, in the switching circuit 200 in accordance with an embodiment of the present invention, since a voltage of less than 0 is applied to the other end of the second shunt switch SW2-1, that is, the second port Port 2, it is possible to further reduce the influence on the second input/output terminal RF2, thus improving the isolation of the switching circuit 200.

Further, the variable potential controller VPC may be interlocked with the above-described controller. For example, in processing a corresponding type of wireless communication signal by the switching circuit 200, a voltage of less than 0 may be applied to the first port Port A or the second port Port B so that the switching circuit 200 can have the optimized insertion loss, isolation, and reflection loss characteristics.

Meanwhile, the first shunt switch SW1-1, the second shunt switch SW2-1, etc. may be implemented by stacking one or a plurality of field effect transistors (FETs).

The switch, such as a FET, may be physically destroyed or may not perform the function when a voltage higher than a breakdown voltage V_{Breakdown} is applied.

Therefore, a voltage (gate-source voltage V_{AS}) between a source terminal connected to the first port Port A or the second port Port B and a gate as a control terminal should be in the range lower than a breakdown voltage of the first shunt switch SW1-1 or the second shunt switch SW2-1, and it is preferred that the voltage applied to the first port Port A or the second port Port B is determined in the range satisfying this.

Further, the voltage applied to the first port Port A or the second port Port B may be determined by the above-described variable potential controller VPC.

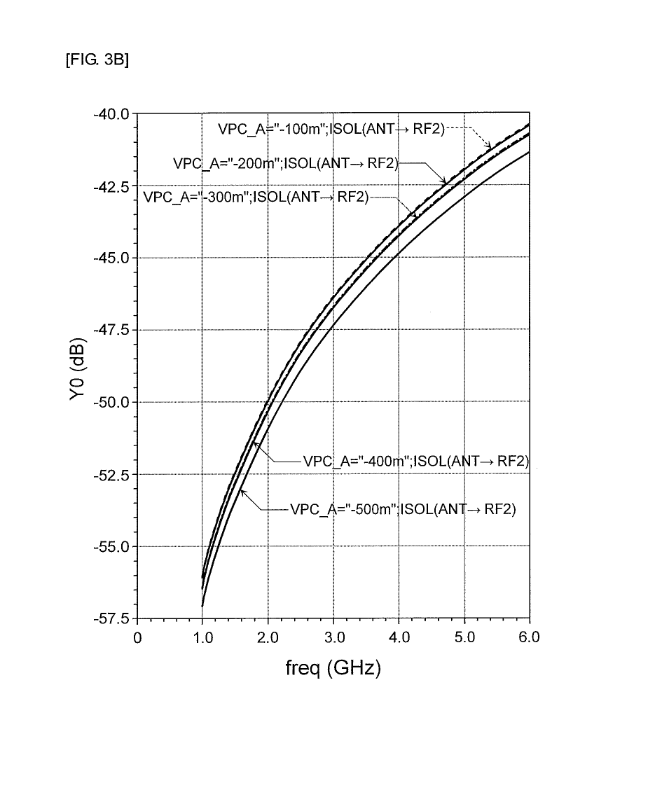

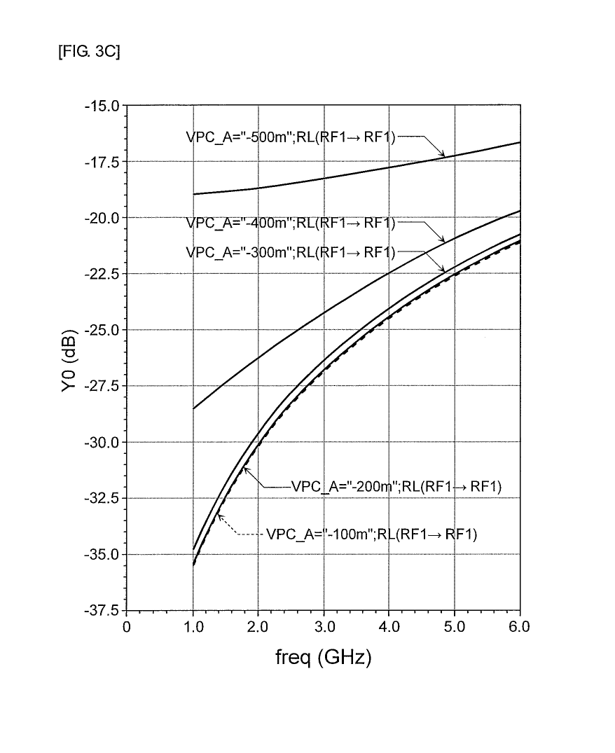

FIG. 3a is a view schematically showing insertion loss characteristics of the switching circuit 100 and 200 in accordance with the embodiment of the present invention, FIG. 3b is a view schematically showing isolation characteristics of the switching circuit 100 and 200 in accordance with the embodiment of the present invention, and FIG. 3c is a view schematically showing reflection loss characteristics of the switching circuit 100 and 200 in accordance with the embodiment of the present invention.

The insertion loss, isolation, and reflection loss according to the application of a voltage of less than 0 to the first port Port A when a signal is transmitted to the antenna ANT from the first input/output terminal RF1 in a state in which the first main switch SW1 and the second shunt switch SW2-1 are turned on and the second main switch SW2 and the first shunt switch SW1-1 are turned off are shown In FIGS. 3a to 3c.

Referring to FIGS. 3a to 3c, it will be understood that the insertion loss, isolation, and reflection loss characteristics are changed according to changes in the voltage VPC_A applied to the first port Port A.

More specifically, the first shunt switch SW1-1 and the second shunt switch SW2-1 may be implemented with FETs. In the circuit in which the wireless signal is transmitted, the switch implemented with a FET exhibits characteristics like a resistor in ON state and exhibits characteristics like a capacitor in OFF state.

Therefore, as a voltage of less than 0 is applied to the first port Port A, the characteristics of the switching circuit 100 and 200 can be changed.

Further, the control signals Vc1 and Vc2 for turning on or off the first shunt switch SW1-1 or the second shunt switch SW2-1 are applied to a gate as a predetermined voltage. When a voltage of less than 0 is applied to the first port Port A or the second port Port B, the characteristics of the switching circuit 100 and 200 become similar to the case in which a voltage of the control signal is increased as much as the voltage applied to the first port Port A or the second port Port B.

It is also possible to adjust the characteristics of the switching circuit through these principles.

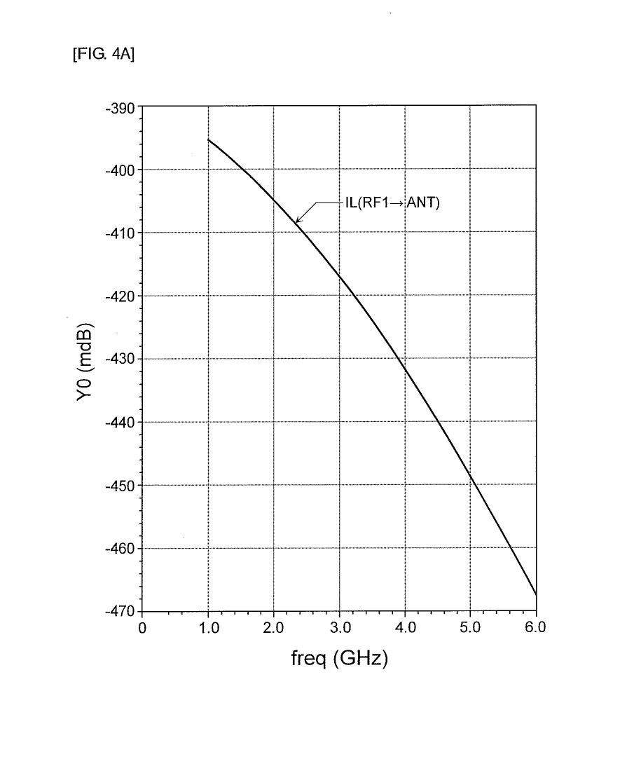

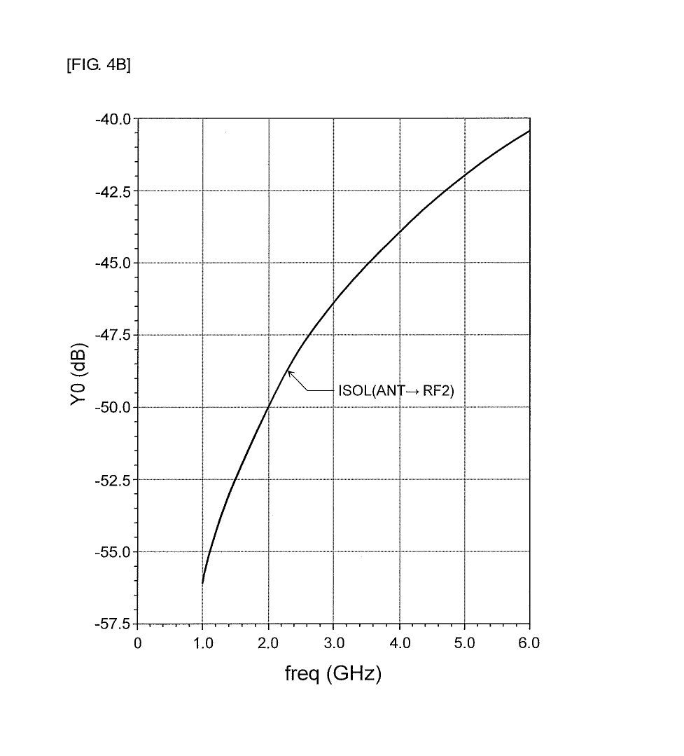

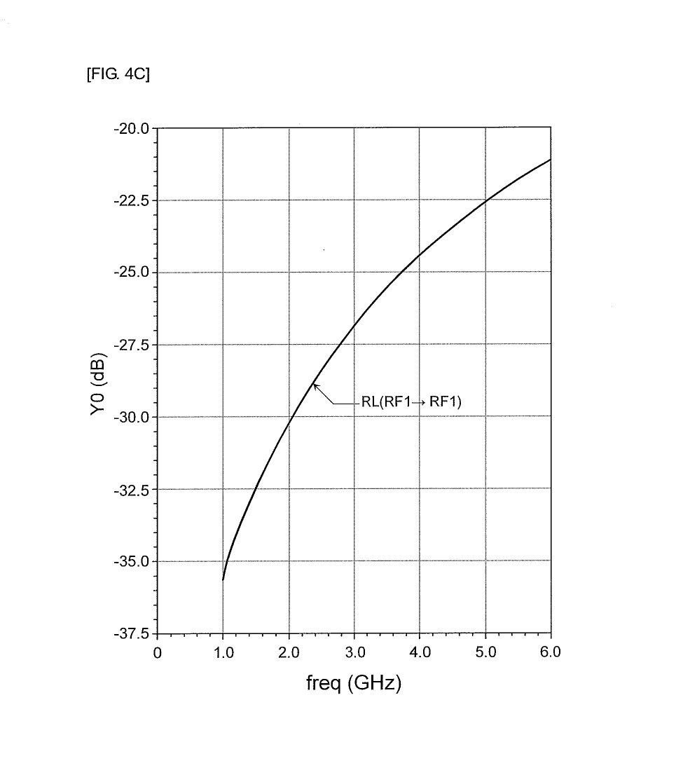

FIG. 4a is a view schematically showing insertion loss characteristics of a switching circuit in accordance with a comparative example, FIG. 4b is a view schematically showing isolation characteristics of the switching circuit in accordance with the comparative example, and FIG. 4c is a view schematically showing reflection loss characteristics of the switching circuit in accordance with the comparative example.

FIGS. 4a to 4c show the characteristics of the switching circuit in which the other end of a shunt switch is grounded. As described, it will be understood that the characteristics of the switching circuit are fixed to predetermined values.

That is, in the switching circuit 100 and 200 in accordance with the embodiment of the present invention, as described in FIGS. 3a to 3c, the characteristics of the switching circuit 100 and 200 can be adjusted according to changes in the size of the voltage of less than 0 applied to the other end of the shunt switch. On the other hand, as described in FIGS. 4a to 4c, the characteristics of the switching circuit are fixed when the other end of the shunt switch is simply grounded.

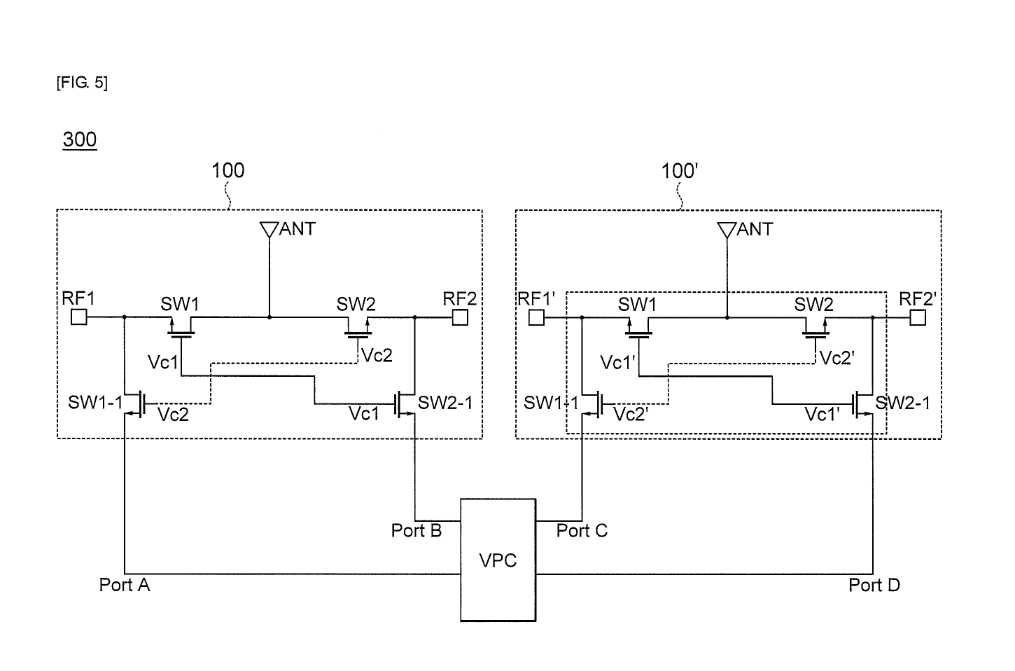

FIG. 5 is a view schematically showing a switching circuit 300 in accordance with an embodiment of the present invention.

Referring to FIG. 5, it will be understood that a plurality of switching circuits 100 and 100′, each of which includes an antenna ANT, a first input/output terminal RF1, a second input/output terminal RF2, a main switch, and a shunt switch, are connected to one variable potential controller VPC so that the characteristics of each switching circuit 100 can be adjusted.

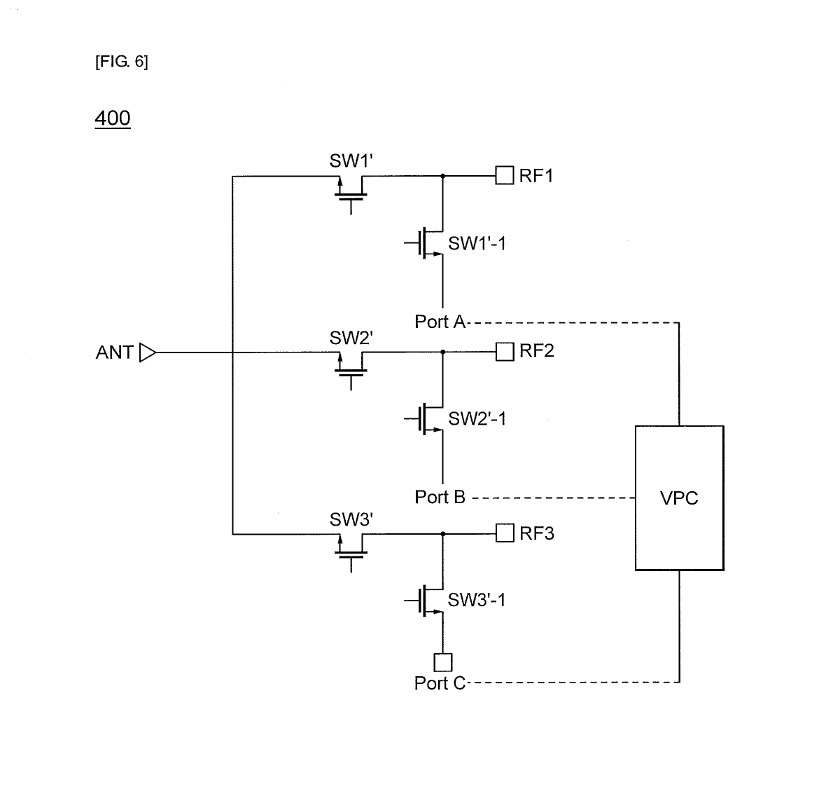

FIG. 6 is a view schematically showing a switching circuit 400 in accordance with an embodiment of the present invention.

Referring to FIG. 6, three or more input/output terminals may be connected to one antenna ANT. For example, a transmitter may be connected to a first input/output terminal RF1, a receiver may be connected to a second input/output terminal RF2, and a Bluetooth transceiver may be connected to a third input/output terminal RF3.

Further, a first main switch SW1′ may be provided between the first input/output terminal RF1 and the antenna ANT, a second main switch SW2′ may be provided between the second input/output terminal RF2 and the antenna ANT, and a third main switch SW3′ may be provided between the third input/output terminal RF3 and the antenna ANT.

Further, one end of a first shunt switch SW1′-1 may be connected between the first input/output terminal RF1 and the first main switch SW1′, one end of a second shunt switch SW2′-1 may be connected between the second input/output terminal RF2 ad the second main switch SW2′, and one end of a third shunt switch SW3′-1 may be connected between the third input/output terminal RF3 and the third main switch SW3′.

At this time, the other end of the first shunt switch SW1′-1 may be connected to a first port Port A, the other end of the second shunt switch SW2′-1 may be connected to a second port Port B, and the other end of the third shunt switch SW3′-1 may be connected to a third port Port C.

Further, the first port Port A, the second port Port B, and the third port Port C may be connected to a variable potential controller VPC to receive a voltage of less than 0.

The switching circuit in accordance with an embodiment of the present invention configured as above can implement improved characteristics than the prior art.

Further, the switching circuit in accordance with an embodiment of the present invention can implement a switching circuit that is optimized to perform each wireless communication method by adjusting insertion loss, isolation, and reflection loss characteristics according to the need.

What is claimed is:

1. A switching circuit comprising:
a plurality of input/output terminals;
at least one antenna;
a plurality of main switches for connecting or disconnecting between each of the plurality of input/output terminals and the antenna; and
a plurality of shunt switches having one ends respectively connected to the plurality of input/output terminals, wherein a voltage of less than 0 is applied to the other end of at least one of the plurality of shunt switches.

2. The switching circuit according to claim 1, wherein the plurality of input/output terminals comprise a first input/output terminal and a second input/output terminal,
the plurality of main switches comprise a first main switch provided between the first input/output terminal and the antenna and a second main switch provided between the second input/output terminal and the antenna,
the plurality of shunt switches comprise a first shunt switch having one end connected to the first input/output terminal and the other end provided with a first port and a second shunt switch having one end connected to the second input/output terminal and the other end provided with a second port, and
the voltage of less than 0 is applied to the first port or the second port.

3. The switching circuit according to claim 2, wherein the first shunt switch or the second shunt switch comprises a control terminal to which a control signal is applied, and
the voltage applied to the first port or the second port is determined in the range in which a voltage between the other end of the first shunt switch or the second shunt switch and the control terminal is lower than a breakdown voltage of the first shunt switch or the second shunt switch.

4. The switching circuit according to claim 3, wherein when the first main switch is in ON state, the second main switch is in OFF state and the second shunt switch is in ON state, and
when the second main switch is in ON state, the first main switch is in OFF state and the first shunt switch is in ON state.

5. The switching circuit according to claim 4, wherein when the first shunt switch is in OFF state, the voltage of less than 0 is applied to the first port, and
when the second shunt switch is in OFF stage, the voltage of less than 0 is applied to the second port.

6. The switching circuit according to claim 5, further comprising:
a variable potential controller connected to the first port and the second port to apply a voltage.

7. The switching circuit according to claim 1, further comprising:
a variable potential controller connected to the other end of at least one of the plurality of shunt switches.

8. The switching circuit according to claim 7, wherein the plurality of shunt switches comprise a control terminal, and
the voltage applied to the other end of the shunt switch by the variable potential controller is determined in the range in which a voltage between the other end of the shunt switch and the control terminal is lower than a breakdown voltage of the shunt switch.

9. The switching circuit according to claim 1, wherein the plurality of input/output terminals comprise a first input/output terminal, a second input/output terminal, and a third input/output terminal,
the plurality of main switches comprise a first main switch provided between the first input/output terminal and the antenna, a second main switch provided between the second input/output terminal and the antenna, and a third main switch provided between the third input/output terminal and the antenna,
the plurality of shunt switches comprise a first shunt switch having one end connected to the first input/output terminal and the other end provided with a first port, a second shunt switch having one end connected to the second input/output terminal and the other end provided with a second port, and a third shunt switch having one end connected to the third input/output terminal and the other end provided with a third port, and
the voltage of less than 0 is applied to at least one of the first port, the second port, and the third port.

10. The switching circuit according to claim 9, further comprising:
a variable potential controller connected to the first port, the second port, and the third port to apply a voltage.
